(19) United States
(12) Patent Application Publication
(10) Pub. No.: US 2011/0109771 A1
(43) Pub. Date: May 12, 2011

(54) IMAGE CAPTURING APPRATUS AND IMAGE CAPTURING METHOD

(76) Inventor: Kenichi ONOMURA, Hino-shi (JP)

(21) Appl. No.: 12/941,508

(22) Filed: Nov. 8, 2010

(30) Foreign Application Priority Data
Nov. 10, 2009 (JP) 2009-257320

(51) Int. Cl. H04N 5/262; H04N 5/225

(52) U.S. Cl. 348/240.3; 348/333.11; 348/E05.024; 348/E05.055

(57) ABSTRACT

An image capturing apparatus is provided which can continuously keep track of an object even under changes of the angle of view during enlarged live-view display, as well as an image capturing method for such an image capturing apparatus. Acquisition range of image signals is controlled by the CPU to crop a portion of an object image formed on the image pickup device. Subsequently, the enlarged live-view display is performed in which the image based on the obtained image signals is enlarged and displayed on the display unit. If a zooming operation is performed during the enlarged live-view display, the CPU obtains information regarding the angle of view and updates the acquisition range of the image signals according to the information regarding the angle of view after the change.

### CROSS-REFERENCE TO RELATED APPLICATIONS

This application is based upon and claims the benefit of priority from prior Japanese Patent Application No. 2009-257320, filed Nov. 10, 2009, the entire contents of which are incorporated herein by reference.

### BACKGROUND OF THE INVENTION

1. Field of the Invention

The present invention relates to an image capturing apparatus having a live-view display function and an image capturing method for such an image capturing apparatus.

2. Description of the Related Art

Recently, a growing number of image capturing apparatus, such as digital cameras for example, are equipped with a live-view display function (so-called through-image display function and the like). The live-view display function continuously displays image data continuously captured by an image pickup device in real-time on a display unit. Such a live-view display function allows a user to view the display unit mounted on the back-surface of a digital camera and the like in order to confirm image composition and the like for photographing.

Meanwhile, functions of image pickup devices have improved. For example, some image pickup devices can read out signals corresponding to only a portion of the area of the image pickup device. Using such a function of the image pickup device, an enlarged live-view display operation became possible. Here, the enlarged live-view operation shall be an operation for enlarging and live-view displaying a portion of the area of a live-view image when this portion of the image is specified by the user. Such an image capturing apparatus having the enlarged live-view display function is proposed in, for example, Japanese Unexamined Patent Application Publication No. 2008-211630.

Typically, during enlarged live-view display, the acquisition position of signals from the image pickup device is fixed to a certain portion. Consequently, if an object observed by the user falls outside the acquisition position of the imaging signals due to a change in angle of view caused by changing lens zoom position, the object the user has been observing may not be displayed in the enlarged live-view.

### BRIEF SUMMARY OF THE INVENTION

Embodiments consistent with the present invention provide an image capturing apparatus which can continuously track an object, even when the angle of view changes during the enlarged live-view display. Such an image capturing apparatus may use exemplary image capturing methods consistent with the present invention.

An image capturing apparatus according to a first exemplary embodiment consistent with the invention includes (1) an image capturing unit for obtaining an image data by capturing an object image formed by a lens system, (2) an image acquisition range control unit for controlling an acquisition range (that is, a portion of the area) of image data obtained by the image capturing unit to define (e.g., crop) a portion of the area of the object image, (3) a display unit for performing an enlarged live-view display operation to display an image obtained by enlarging the image data within the acquisition range, and (4) an object information obtaining unit for obtaining object image information regarding a change of a position of an object image formed by the lens system due to a change in an angle of view, wherein the image acquisition range control unit updates the acquisition range according to the object image information after the change of position if the object image information changes during the enlarged live-view display on the display unit. The first exemplary embodiment may include the lens system (referred to simply as a “lens”) for forming an object image.

Further, an image capturing method according to a second exemplary embodiment consistent with the invention (1) obtains an image data by capturing an object image formed by a lens, (2) controls an acquisition range of the obtained image data to define (e.g., crop) a portion of the area of the object image in response to a change of object image information regarding a change of a position of the captured image data and (3) enlarges and displays an image data in the acquisition range.

### BRIEF DESCRIPTION OF THE SEVERAL VIEWS OF THE DRAWING

FIG. 1 is a diagram showing a structure of a digital camera as an example of an image capturing apparatus according to one embodiment consistent with the present invention.

FIG. 2 is a flow chart showing process of the image capturing method according to the present embodiment during a live-view display operation of a digital camera as an example.

FIG. 3 is a diagram illustrating the acquisition range of image data in a normal live-view display mode.

FIG. 4 is a diagram illustrating an example of image data displayed on a display unit in a normal live-view display operation.

FIGS. 5A and 5B are diagrams illustrating the acquisition range of image data in an enlarged live-view display mode.

FIG. 6 is a diagram illustrating an example of image data displayed on display unit in an enlarged live-view display operation.

FIGS. 7A, 7B, 7C, 7D, 7E, and 7F are diagrams illustrating an updating of the acquisition range and the corresponding changes in the live view display.

FIG. 8 is diagram illustrating an example of a method for updating the acquisition range of an image data in enlarged live-view display mode.

FIGS. 9A and 9B are diagrams illustrating a warning when an acquisition range falls outside of an image pickup device.

FIGS. 10A, 10B, 100 and 10D are diagrams illustrating an example of modifications in which an electronic blurring correction is combined with the improved live-view display.

### DETAILED DESCRIPTION OF THE INVENTION

Referring to the drawings, embodiments according to the present invention will be described below.

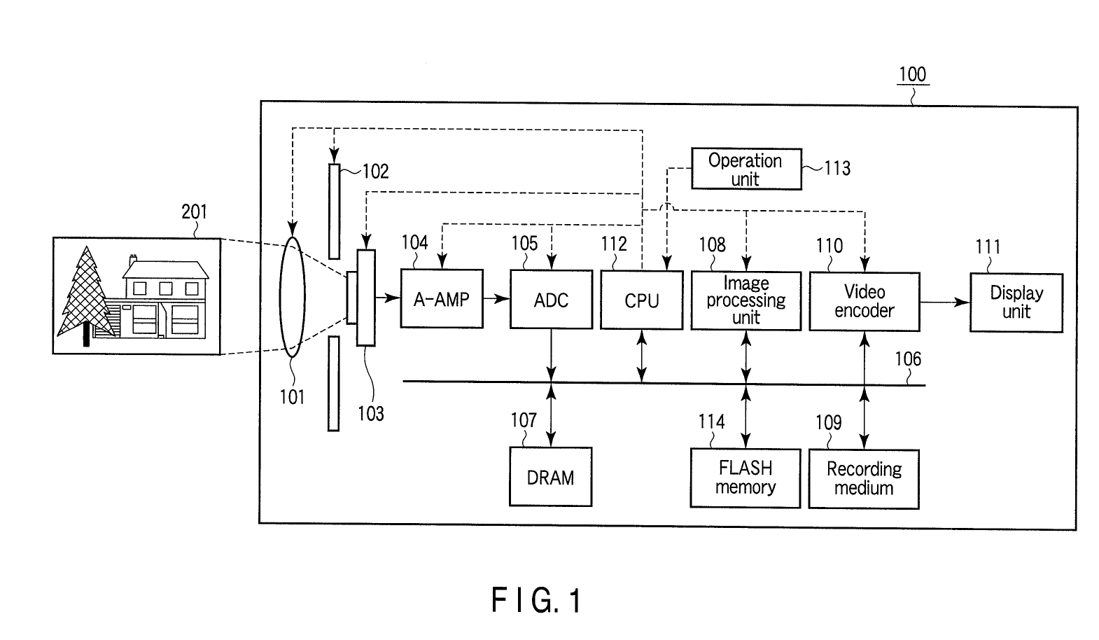

FIG. 1 is a diagram showing a structure of a digital camera as an example of an image capturing apparatus according to one embodiment of the invention. The digital camera shown in FIG. 1 includes lens 101, aperture 102, image pickup device 103, analog amplifier (A-AMP) 104, analog/digital converter (ADC) 105, bus 106, DRAM 107, image processing unit 108, recording medium 109, video encoder 110, display unit 111, CPU 112, operation unit 113 and FLASH memory 114. Although FIG. 1 shows an example of a configuration in which the lens 101 is integrated in the digital camera 100, embodiments consistent with the present invention may be used in digital camera bodies which can accommodate interchangeable lenses.

The lens 101 defines an optical system including a plurality of lenses, such as (1) a zoom lens for changing an angle of view of image data obtained by the image pickup device 103 and (2) a focusing lens for adjusting a focal position of the lens 101. The lens 101 forms an object image 201 on the image pickup device 103. The zoom lens and the focusing lens of the lens 101 are driven and controlled by the CPU 112. Note that manual adjustments of the zoom lens, and/or of the focusing lens of the lens 101 are communicated to the CPU 112 (e.g., for purposes of image processing). The aperture 102 is disposed between the lens 101 and the image pickup device 103 and controls the amount of incident light on a photoelectric conversion surface of the image pickup device 103. The aperture 102 is controlled for opening and closing by the CPU 112. Even manual adjustments to the aperture 102 are communicated to the CPU 112.

The image pickup device 103 includes a photoelectric conversion surface for receiving light of the object image 201 incident through the lens 101. The photoelectric conversion surface includes a two-dimensional array of pixels (like photoelectric conversion elements (e.g. photodiode)) which converts an amount of light into a charge amount. Such an image pickup device 103 converts the object image 201, which is incident through the lens 101, into electrical signals (image signals) and outputs them to the A-AMP 104. Operations of the image pickup device 103 and read-out of the electrical signals which are obtained in the image pickup device 103 are controlled by the CPU 112, which serves as an image acquisition range control unit.

An exemplary image pickup device 103 according to the present embodiment shall be capable of reading-out image signals in units of pixel(s) or in units of row(s) of the photoelectric conversion surface. Examples of such an image pickup device capable of reading-out image signals in units of pixel(s) or row(s) include a CMOS image pickup device. The capability of reading-out the image signals in units of pixel(s) or row(s) enables the CPU 112 to control the acquisition range of the image signals obtained in the image pickup device 103 to define (e.g., crop) a portion of the object image 201.

The A-AMP 104 amplifies the image signals read-out from the image pickup device 103 by a predetermined amplification factor which may be specified by the CPU 112. The ADC 105 converts analog image signals output from the A-AMP 104 into digital image signals (hereafter called image data).

The bus 106 provides a transmission path for transferring various data generated in the digital camera 100 to other portions of the digital camera 100. The bus 106 is connected to the ADC 105, the DRAM 107, the image processing unit 108, the recording medium 109, the video encoder 110, the CPU 112 and the FLASH memory 114.

The DRAM 107 is a recording unit for temporarily recording various data such as image data obtained in the ADC 105 or those processed in the image processing unit 108.

The image processing unit 108 performs various image-processing operations on the image data obtained in the ADC 105 and recorded in the DRAM 107. For example, the image processing unit 108 may function as an electronic blurring detecting unit in some exemplary embodiments. More specifically, during live-view display (described further below), the image processing unit 108 in such exemplary embodiments detects motion vectors of the object in image data obtained successively by the image pickup device 103. Such motion vectors may indicate a blur amount of the object in the image data. The CPU 112 may be used to correct the blur of the object in the image data by controlling the acquisition range of signals from the image pickup device 103 so that the blur amount detected in the image processing unit 108 is corrected. Further, the image processing unit 108 in some exemplary embodiments may perform other image-processing such as white balance correction processing, color correction processing, gamma conversion processing, resize processing, and/or compression processing. Furthermore, when playing back images, an expansion processing of compressed image data is performed.

An image data obtained by a shooting (e.g., shutter release) operation is stored in the recording medium 109. Examples of the recording medium 109 include a semiconductor memory designed to be attached to, and detached from, the digital camera 100 but are not limited to this.

The video encoder 110 performs various processes for displaying image data on the display unit 111. Specifically, the video encoder 110 may process image data for display by reading out the image data, which was resized based on factors such as a display size of the display unit 111 and recorded in the DRAM 107, from the DRAM 107. The video encoder 110 may then convert the read-out image data into video signals, and finally output the result to the display unit 111. Examples of the display unit 111 include a liquid crystal display unit.

The CPU 112 may control various operations of the digital camera 100. If the operation unit 113 is operated by a user, the CPU 112 reads out a program necessary for executing a corresponding operation having instructions stored in the FLASH memory 114 and executes the sequence of instructions to perform the desired operation. Further, the CPU 112 may serve as an object information obtaining unit which obtains object information recorded in the FLASH memory 114 and controls the acquisition range of the image pickup device 103. This object information will be described later.

The operation unit 113 may include one or more operation members such as a release button, a power button, a zoom button, entry keys and the like. When any operation member of the operation unit 113 is operated by the user, the CPU 112 executes a sequence of stored instructions corresponding to the user's operation.

Parameters necessary for digital camera operations and programs executed by the CPU 112 may be stored in the FLASH memory 114. Following the program stored in the FLASH memory 114, the CPU 112 may read out the necessary parameters for each operation from the FLASH memory 114 and execute sequences of instructions corresponding to the desired operation. Object image information regarding the lens 101 is stored in the FLASH memory 114, according to one exemplary embodiment of the invention, as one of the parameters necessary for digital camera operations. The object image information includes information regarding the change in position of the object image formed by the image pickup device 103, which includes information regarding the angle of view of the lens 101. Such angle of view information of the lens 101 may include the positions of the zoom lens and the focusing lens. Further, the FLASH memory 114 may also store image data for displaying an enlarging frame which is displayed within a live-view image when displaying normal live-view described later.

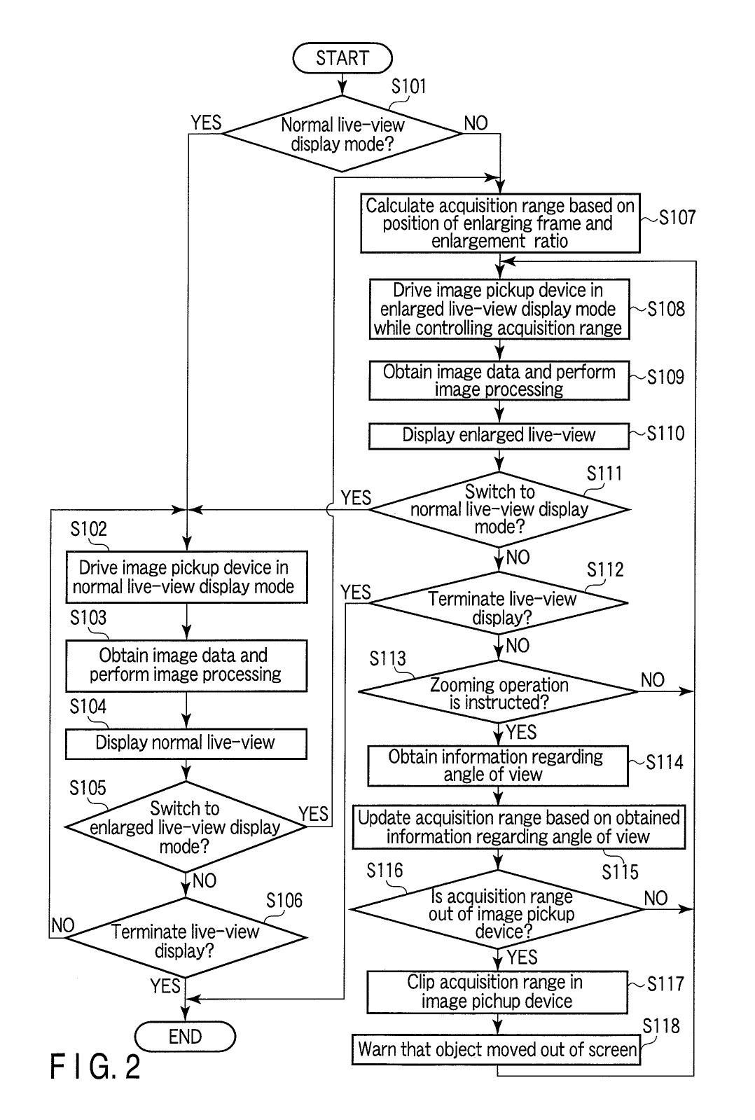

Next, exemplary live-view display operations of the exemplary digital camera 100 consistent with the present invention will be described with reference to FIG. 2. FIG. 2 is a flow chart showing the process during the exemplary live-view display operation of the digital camera 100 as an example of an exemplary image capturing method consistent with the present invention.

The process shown in FIG. 2 is started when the live-view display is performed, for example after turning on the digital camera 100. After the process shown in FIG. 2 is started, the CPU 112 determines whether or not the current live-view display mode of the digital camera 100 is a normal live-view display mode (step S101). (In this exemplary embodiment, a normal live-view display mode and an enlarged live-view display mode are provided as live-view display modes. The normal live-view display mode is a live-view display mode to display an image corresponding to (e.g., substantially) the entire pixel area of the image pickup device 103 (entire angle of view) in real time on the display unit 111. On the other hand, the enlarged live-view display mode is a live-view display mode to enlarge and display in real-time image data corresponding to a portion of the (e.g., substantially) entire area specified by the user, at an enlargement ratio specified by the user, on the display unit 111. Although the normal live-view display mode was described as displaying an image corresponding to (e.g., substantially) the entire pixel area of the image pickup device, the normal live-view display mode may display a predetermined pixel area corresponding to the normal live-view display mode. Although it may be desired to display as much of the pixel area as possible, in some instances, it may be necessary to not display certain pixels such as, for example, if the aspect ratio of the display differs from that of the image pickup device. If an operation member of the operation unit 113 for switching between the live-view display mode is provided, the user can switch between the normal live-view display mode and the enlarged live-view display mode using the operation unit 113. Alternatively, switching between the normal live-view display mode and the enlarged live-view display mode may be done via a menu screen of the digital camera 100. Additionally, the normal live-view display mode can be switched to the enlarged live-view display mode in response to the user specifying a range in the display unit 111 during the normal live-view displaying, which will be described in detail later.

When it is determined at step S101 that current live-view display mode is the normal live-view display mode (or when switching over to the normal live-view display mode is determined at step S111 which will be described later), the CPU 112 drives the image pickup device 103 in a mode for the normal live-view display in order to perform the normal live-view display operation (step S102). In this case, the CPU 112 determines the entire pixel area of the image pickup device 103 as the acquisition range of the image signals.

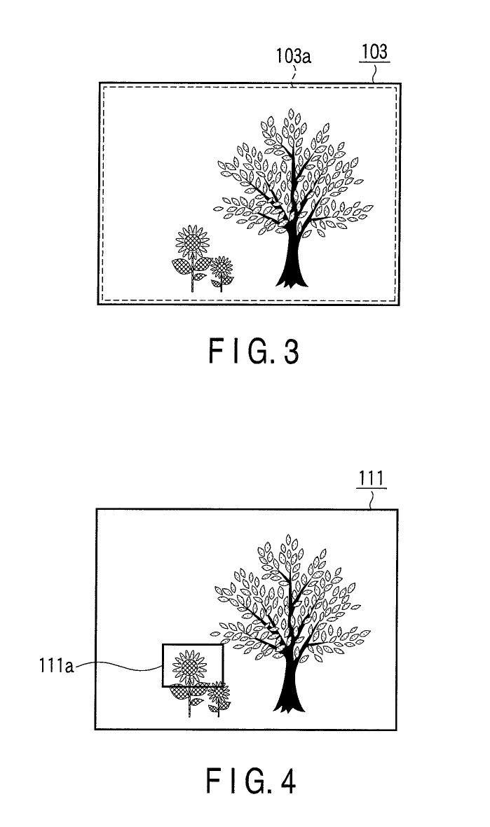

FIG. 3 is a diagram illustrating the acquisition range of the image signals in the normal live-view display mode. In the normal live-view display mode, the CPU 112 controls the acquisition range in order to read out the image signals in an acquisition range 103a corresponding with the entire pixel region of the image pickup device 103 (entire angle of view) shown on FIG. 3. In the normal live-view display mode, it is preferable to read out the image signals by thinned-out scanning in order to reduce the time for reading-out the image signals and for image-processing. This enables displaying the image data at a high frame rate, although the resolution of the image displayed on the display unit 111 is reduced.

Referring back to FIG. 2, after the image pickup device 103 is driven, the image signals corresponding to the entire pixel region of the image pickup device 103 (or every couple of lines in the event of thinned-out scanning) are output. The image signals are converted into digital image data(image data) by the ADC 105 after amplifying with the A-AMP 104. Then, the image data is stored in the DRAM 107 via the bus 106. Subsequently, the CPU 112 instructs the image-processing unit 108 to image-process the image data stored in the DRAM 107. In response to this, the image-processing unit 108 reads out the image data from the DRAM 107 and performs image processing of the read-out image data (step S103). The image data image-processed by the image-processing unit 108 is stored in the DRAM 107. After this, the CPU 112 instructs the video encoder 110 to perform the execution of the normal live-view display. In response to this, the video encoder 110 reads out the image data from the DRAM 107, converts the read-out image data to video signals and outputs video signals to the display unit 111, which displays the live-view image. Further, the video encoder 110 reads out from the FLASH memory 114 image data for displaying an enlarging frame (See, e.g., element 111a of FIG. 4, described below.), converts this image data for displaying the enlarging frame into video signals, and outputs the video signals to the display unit 111, which superimposes the display of the enlarging frame on the live-view image (which is being displayed on the display unit 111) (step S104). The display position of the enlarging frame might be, for example, the display position of the enlarging frame during the last normal live-view display.

FIG. 4 is a diagram illustrating an example of an image displayed on the display unit 111 by the normal live-view display operation. As shown in FIG. 4, in the normal live-view display mode, a live-view image corresponding to the entire angle of view of the image pickup device 103 shown in FIG. 3 is displayed. Further, a rectangular enlarging frame 111a is superimposed on the live-view image. The enlarging frame 111a can be moved across the screen of the display unit 111 in accordance with operations of the operation unit 113 by the user. That is, the user can select a small area in the screen of the display unit 111 using the enlarging frame 111a.

Referring back to FIG. 2, after the normal live-view image is displayed, the CPU 112 determines whether or not the live-view display mode is switched to the enlarged live-view display mode (step S105). The determination of switching the live-view display mode to the enlarged live-view display mode is made, for example, when the switch to the enlarged live-view display mode is instructed by a user via the operation unit 113 or via the menu screen of the digital camera 100, or when a small area in the screen of the display unit 111 is selected with the enlarging frame 111a by the user. When it is determined at step S105 that the live-view display mode is not switched to the enlarged live-view display mode, the CPU 112 determines whether or not the live-view display operation is terminated (step S106). The determination of terminating the live-view display operation is made, for example, when the power of the digital camera 100 is turned off or when shooting execution of the digital camera 100 is instructed by a user via a (shutter) release (or image capture) button operation. When it is determined at step S106 that the live-view display operation is not terminated, the process returns to step S102. In this case, the CPU 112 continues the operations corresponding to the normal live-view display mode. On the other hand, when it is determined at step S106 that the live-view display operation is terminated, the CPU 112 terminates the process shown in FIG. 2. After that, the CPU 112 turns off the digital camera 100, or executes shooting, or performs some other desired operation.

When it is determined at step S101 that the current live-view display mode is the enlarged live-view display mode, or when it is determined at step S105 that the live-view display mode is switched to the enlarged live-view display mode, the CPU 112 calculates an acquisition range of the image signals in the image pickup device 103 based on a current position of the enlarging frame 111a and the enlargement ratio specified by the user via an operation of the operation unit 113 and the like (step S107). This acquisition range is the range on the image pickup device 103 corresponding to the enlarging frame 111a in the display unit 111.

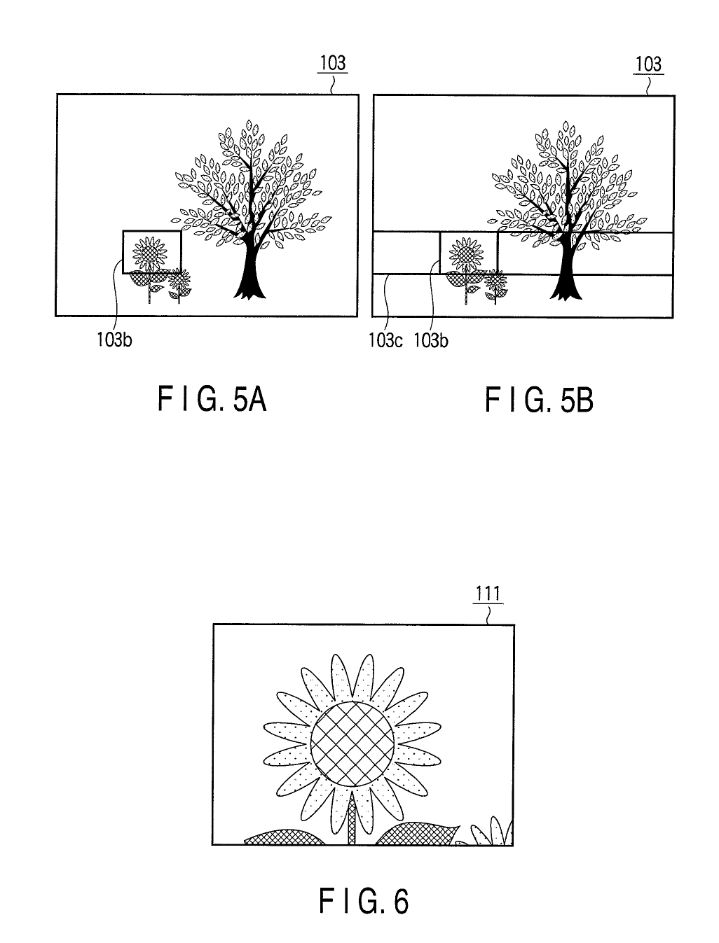

After the acquisition range is calculated, the CPU 112 drives the image pickup device 103 in a mode for the enlarged live-view display in order to perform the enlarged live-view display operation (step S108). FIGS. 5A and 5B are diagrams illustrating the acquisition range of the image signals in the enlarged live-view display mode. If the image pickup device 103 can read-out image signals in units of pixels, the CPU 112 controls the acquisition range to read out image signals in an acquisition range 103b, which is shown in FIGS. 5A and 5B, and is a range corresponding to the enlarging frame 111a. In the enlarged live-view display mode, it is preferable (though not necessary) to read out the image signals without thinned-out scanning. Compared to the acquisition range in the normal live-view display mode, the range in the enlarged live-view display mode is smaller. For this reason, the time for reading-out the image signals and image-processing are shorter even without thinned-out scanning because there are less pixels in the area defined by the acquisition range. Consequently, in the enlarged live-view display mode, the image signals are preferably read out without thinned-out scanning so that the resolution of the image is not degraded. On the other hand, if the image pickup device 103 is an image pickup device capable of reading-out image signals only in units of lines, the CPU 112 controls the acquisition range to specify a zonal region 103c which includes the acquisition range 103b, as the actual acquisition range as shown in FIG. 5B.

Referring back to FIG. 2, after the image pickup device 103 is driven (step S108), image signals corresponding to the acquisition range 103b (or the acquisition range 103c) of the image pickup device 103 are output. The image signals are amplified by the A-AMP 104 and then converted into digital image data by the ADC 105. Then, the image data is stored in the DRAM 107 via the bus 106. After that, the CPU 112 instructs the image-processing unit 108 to image-process the image data stored in the DRAM 107. In response to this, the image-processing unit 108 reads out the image data from the DRAM 107 and then performs image processing of the read-out image data (step S109). Note that even if the acquisition range of the image signals is the acquisition range 103c, only image-processing of the image data corresponding to the acquisition range 103b might be performed in order to avoid unnecessarily processing image data that won't be displayed. The image data processed by the image-processing unit 108 is stored in the DRAM 107. After that, the CPU 112 instructs the video encoder 110 to execute the enlarged live-view display. In response to this, the video encoder 110 reads out the image data from the DRAM 107 (which was resized in the image-processing unit 108 based on the enlargement ratio specified by the user such as via operation of the operation unit 113), converts the read-out image data to video signals and outputs the video signals to the display unit 111 to display the live-view image (step S110). FIG. 6 illustrates an example of the image which is displayed on the display unit 111 by an enlarged live-view display operation.

After the enlarged live-view image is displayed, the CPU 112 determines whether or not the live-view display mode is switched to the normal live-view display mode (step S111). The determination of switching the live-view display mode to the normal live-view display mode is made, for example, when a switch to the normal live-view display mode is instructed by a user via the operation unit 113, or via the menu screen of the digital camera 100. When it is determined at step S111 that the live-view display mode is not switched to the normal live-view display mode, the CPU 112 determines whether or not the live-view display operation is terminated (step S112). When it is determined at step S112 that the live-view display operation is terminated, the CPU 112 terminates the process shown in FIG. 2. After that, the CPU 112, for example, turns off the digital camera 100, or executes shooting.

On the other hand, when it is determined at step S112 that the live-view display operation is not terminated, the CPU 112 determines whether or not a zooming operation has been instructed by the user (including a direct operation of a zoom ring, a zoom button operation of the operation unit 113) (step S113, etc.). When it is determined at step S113 that the zooming operation has not been instructed, the process returns to step S108. In this case, the CPU 112 continues the operation corresponding to the enlarged live-view display mode using the current acquisition range 103b (or the acquisition range 103c).

On the other hand, when it is determined at step S113 that the zooming operation has been instructed, the CPU 112 obtains information regarding angle of view of the lens 101 (e.g., position information of zoom lens and focusing lens) as object image information (step S114). The CPU 112 then updates the acquisition range of the image signals based on the obtained information regarding the angle of view (step S115).

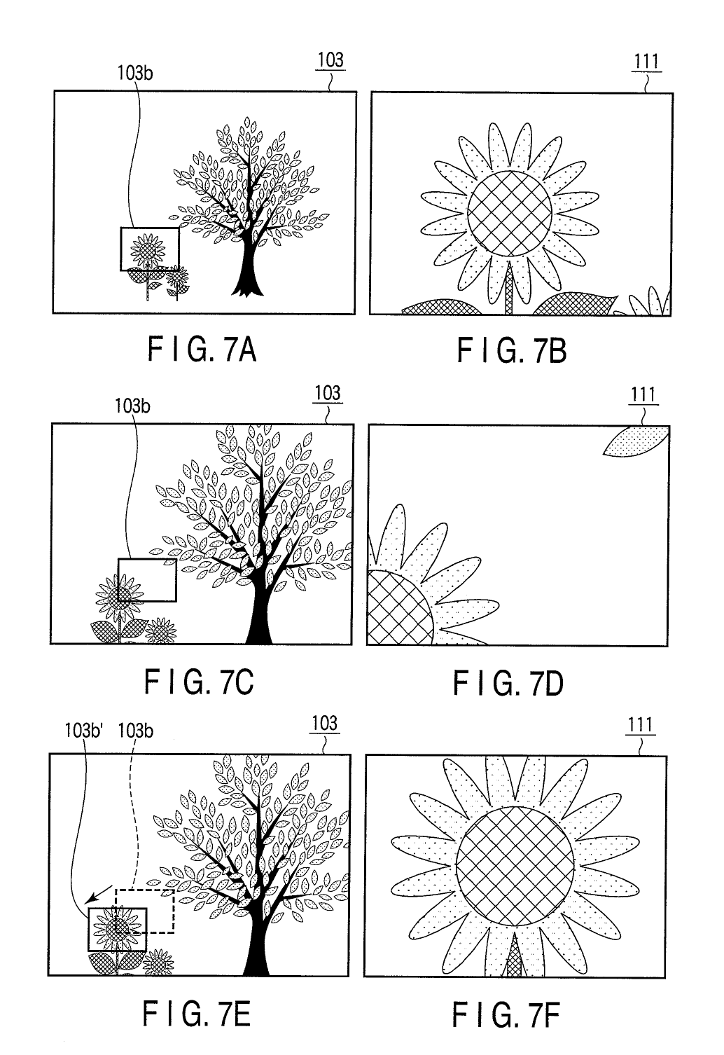

The update of the acquisition range will be described. In the normal live-view display mode, if an enlarging frame is selected, a switch to the enlarged live-view display mode from the normal live-view display mode is performed. In this case, a portion of the image pickup device 103 is specified as an acquisition range 103b as shown in FIG. 7A, and image signals are read out from the image pickup device 103. As a result, the enlarged live-view image is displayed as shown in FIG. 7B.

If a zooming operation is performed during the enlarged live-view display, the angle of view of the image obtained via the image pickup device 103 changes. For example, FIG. 7C illustrates the state of the object image formed on the image pickup device 103 when the lens 101 is driven to tele (zoom in) side in the situation of FIG. 7B. If the acquisition range of the image signals were to remain the same (i.e., acquisition range 103b) despite the change in the angle of view, a live-view image as shown in FIG. 7D is displayed as a result of the enlarged live-view display. That is, since the object position which the user is trying to track changes with the change in the angle of view, the object position which the user is trying to track moves to an edge of the screen in the display unit 111 after displaying the enlarged live-view image. An update of the acquisition range of the image signals from the acquisition range 103b to the acquisition range 103b′ is necessary, as shown in FIG. 7E, in order to avoid such a position movement of the object image. Accordingly, such an update of the acquisition range enables displaying the object image which the user is trying to track at the center of the display unit 111 all the time, as shown in FIG. 7F, even if the angle of view changes.

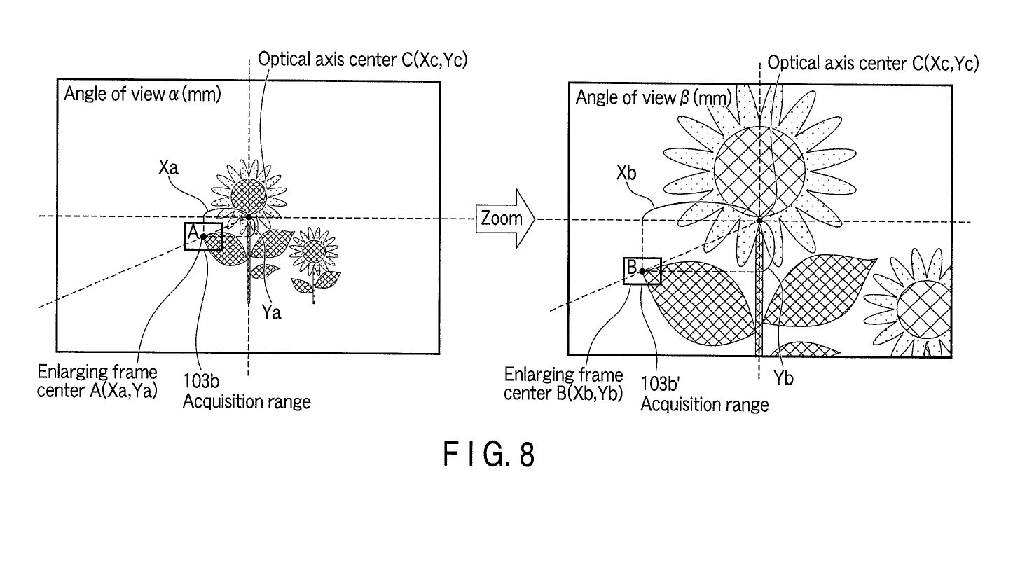

FIG. 8 is diagram illustrating an example of a method for updating the acquisition range. Here, FIG. 8 shows the state of the object image on the image pickup device 103 before and after the change in the angle of view of the lens 101 from α (mm) to β (mm) in term of the focal length of the lens 101, respectively. In FIG. 8, the state of the image pickup device 103 before the change in angle of view is shown, while the state of the image pickup device 103 after the change in the angle of view is shown in FIG. 8. As shown in FIG. 8, the projected position of the object image on the pickup device 103 changes before and after the change in the angle of view. As a result, the object image displayed in the enlarged live-view will change. Consequently, for example, in order to display, after changing the angle of view, an enlarged live-view of an object image corresponding to an object image at the same position within the acquisition range 103b centered at position A (Xa, Ya) on the image pickup device 103 before the change of the angle of view, it is necessary to display the enlarged live-view of an object image within the acquisition range 103b′ whose center is at position B (Xb, Yb) on the image pickup device 103 after the change of the angle of view.

Here, as shown in FIG. 8, the position C (Xc, Yc) of the optical axis center on the image pickup device 103 does not change before and after the change in the angle of view. Consequently, the relationship below is established between the position A before the change in angle of view and the position B after the change in angle of view:

α:β=(Xa−Xc):(Xb−Xc)

α:β=(Ya−Yc):(Yb−Yc)

Consequently, coordinate conversion from position A to position B is possible according to following formulas:

Xb=β/α×(Xa−Xc)+Xc

Yb=β/α×(Ya−Yc)+Yc (Formula 1)

By obtaining the image signals from the acquisition range 103b′ whose center is the position B (Xb, Yb), it becomes possible to keep reading out the “same” object image before and after the change in angle of view. Note that although the displays of FIGS. 7B and 7F are not exactly the same, the object displayed is the same, and the displayed object has the same (or substantially the same) center in each display.

Referring back to FIG. 2, the acquisition range after the update may be calculated as above-described (Step S115), whereupon the CPU 112 determines whether or not the acquisition range after the update is out of the capturing range (i.e., the area of the photoelectric conversion surface) of the image pickup device 103 (step S116). When it is determined at step S116 that the acquisition range after the update is within the capturing range of the image pickup device 103, the process returns to step S108. In this case, the CPU 112 continues to perform the enlarged live-view display mode operations using the updated acquisition range 103b′ (or using a zonal region including the acquisition range 103b′). (Recall 103c of FIG. 5(b).)

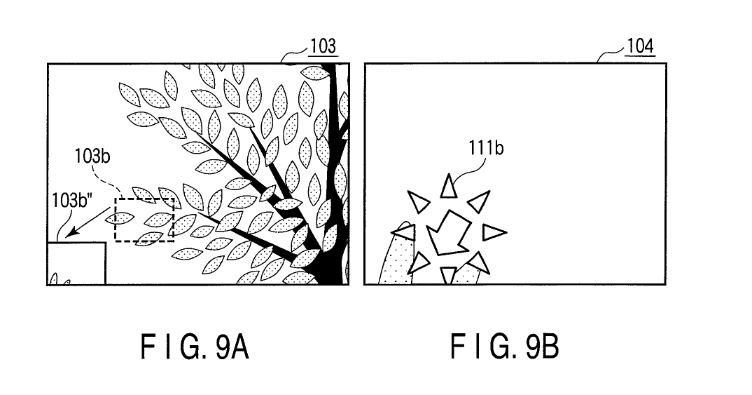

On the other hand, when it is determined at step S116 that the acquisition range after the update is out of the capturing range of the image pickup device 103, the CPU 112 “clips” the acquisition range after the update to move it back to within the capturing range of the image pickup device 103 (step S117). The CPU 112 also informs the user that the object image has moved out of the capturing range of the image pickup device 103 and thus moved out of the screen of the display unit 111. The user may be so informed, for example, by certain displays on the display unit 111 (step S118). After that, the process returns to step S108. In this case, the CPU 112 performs an operation corresponding to the enlarged live-view display mode using the acquisition range 103b″ after “clipping”. For example, as shown in FIG. 9A, if the updated acquisition range 103b′ reaches to an edge of the capturing range of the image pickup device 103, it is impossible to display the object image at the center of the display unit 111 in the enlarged live-view display operation if the capturing range is moved any further from the center. In such a situation, a warning, such as that 111b shown in FIG. 9B, is displayed. Naturally, such a warning can be performed by means other than the display shown.

As described above, according to the embodiment, if the image obtained via the image pickup device 103 changes due to, for example, changes in the angle of the view, the acquisition range of the image signals is controlled to display the same object image in the enlarged live-view display mode before and after the change in the angle of the view. This enables the user to observe the desired object image while keeping track of it at the center of the screen without the need for the user to manually enter instructions to move the enlarging frame 111a with each zooming operation.

Further, if the updated acquisition range moves out of the capturing range of the image pickup device 103, a live-view display of a portion outside the capturing range cannot be performed. During the enlarged live-view display, since the portion of the image obtained via the image pickup device 103 is enlarged and displayed, it is difficult for the user to recognize that the updated acquisition range moved out of the capturing range of the image pickup device 103. In the embodiment, if the updated acquisition range moves out of the capturing range of the image pickup device 103, the user will be warned. Thus, the user can recognize easily that the updated acquisition range is out of the capturing range of the image pickup device 103. As a result, it is expected that the user will point the digital camera 100 at the object and/or restore the angle of view by a zooming operation (zoom out) so that the desired object can be displayed at the center of the screen of the display unit 111.

In the above-described exemplary embodiment, only the position of the acquisition range is controlled in accordance with the change in the angle of view and the enlargement ratio is kept unchanged. Therefore, the enlarged live-view image is larger in FIG. 7F than in FIG. 7B due to the effect of zooming (change in the angle of view). Alternatively, it is possible to maintain the size of the image displayed in the enlarged live-view display mode without regard to the zooming operation. In such a case, the acquisition range can be controlled so that enlargement ratios of the object are changed before and after the change in the angle of view.

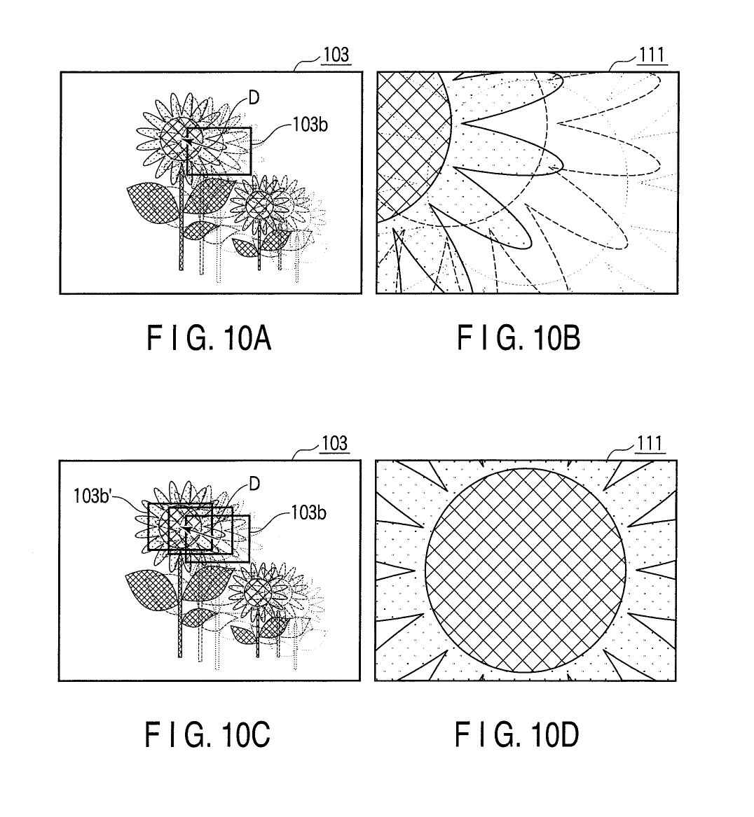

In the above-described exemplary embodiment, the information regarding the angle of view was used as the object information. In addition to the information regarding angle of view, a vibration amount detected by the electronic blurring detection of the image processing unit 108 can be used as object information. For example, as shown in FIG. 10A, if vibration of the digital camera 100 is produced in a direction D, the position of the object image projected on the image pickup device 103 is blurred due to the vibration. In this case, the object image which was tracked at the center of the acquisition range 103b may move out of the acquisition range 103b, and/or an image enlarged live-view displayed is also blurred as shown in FIG. 10B. If such a blur of the displayed image of the digital camera 100 occurs, an acquisition range 103b′, which has been shifted by the motion vector D from an original acquisition range 103b, may be updated as shown in FIG. 10C. Then, in accordance with image signals in the updated acquisition range 103b′, the enlarged live-view display is performed. Accordingly, as shown in FIG. 10D, even during the live-view display, the object image can remain displayed without blur, and the user's desired object image remains displayed at the center of the screen.

The invention has been described above based on the embodiments, but the invention is not limited to the above-described embodiments, and there can be variations in various shapes and applications of the present invention within the scope of the present invention. For example, although the above-described embodiment shows an example wherein the lens 101 is configured integrally with the digital camera 100, other exemplary embodiments consistent with the present invention can be applied to a camera with interchangeable lenses. In this case, information regarding the angle of view as object information is stored in the interchangeable lens. Thus, the information regarding angle of view is obtained by communication between the body of the digital camera 100 and the interchangeable lens.

Further, the above-described embodiments include various phases of the invention so that various inventions can be extracted by appropriate combinations of a plurality of disclosed structure elements. For example, even if some structured elements shown in the embodiments are removed, if the above-described problems can be solved and similar effect(s) to the above can be obtained, the resulting structure, in which some structured elements have been removed, can also be chosen as an invention.

What is claimed is:

1. An image capturing apparatus comprising:
an image capturing unit having a lens for forming an object image and for obtaining image data by capturing an object image formed by the lens;
an image acquisition range control unit for controlling an acquisition range of image data obtained in the image capturing unit to crop a portion of the object image;
a display unit for performing an enlarged live-view display operation to display an image obtained by enlarging the image data within the acquisition range; and
an object information obtaining unit for obtaining object image information regarding a change of a position of an object image formed by the image capturing unit, wherein
if the object image information changes during the enlarged live-view display on the display unit, the image acquisition range control unit updates the acquisition range according to the object image information after the change.

2. The image capturing apparatus according to claim 1, wherein the image acquisition range control unit updates the acquisition range such that a center position of an object image in an image data displayed in the enlarged live-view display on the display unit does not change before and after a change of the object image information.

3. The image capturing apparatus according to claim 1, wherein if a position of an object image in an image data displayed in the enlarged live-view on the display unit before a change in the object image information moves out of a capturing range of the image capturing unit as a result of a change in the object information, a warning that the object image cannot be tracked is given.

4. The image capturing apparatus according to claim 1, wherein the object image information obtained by the object information obtaining unit is information regarding angle of view for shooting.

5. The image capturing apparatus according to claim 2, wherein the object image information obtained by the object information obtaining unit is information regarding angle of view for shooting.

6. The image capturing apparatus according to claim 3, wherein the object image information obtained by the object information obtaining unit is information regarding angle of view for shooting.

7. The image capturing apparatus according to claim 4, wherein the lens comprises a zoom lens for changing the angle of view of image data obtained by the image capturing unit, and wherein the information regarding the angle of view for shooting includes information regarding a position of the zoom lens.

8. The image capturing apparatus according to claim 5, wherein the lens comprises a zoom lens for changing the angle of view of an image data obtained by the image capturing unit, and wherein the information regarding the angle of view for shooting includes information regarding a position of the zoom lens.

9. The image capturing apparatus according to claim 6, wherein the lens comprises a zoom lens for changing the angle of view of image data obtained by the image capturing unit, and wherein the information regarding the angle of view for shooting includes information regarding a position of the zoom lens.

10. The image capturing apparatus according to claim 4, wherein the lens comprises a focusing lens for adjusting focal length of the lens, and wherein the information regarding the angle of view for shooting includes information regarding a position of the focusing lens.

11. The image capturing apparatus according to claim 5, wherein the lens comprises a focusing lens for adjusting focal length of the lens, and wherein the information regarding the angle of view for shooting includes information regarding a position of the focusing lens.

12. The image capturing apparatus according to claim 6, wherein the lens comprises a focusing lens for adjusting focal length of the lens; and information regarding the angle of view for shooting includes information regarding a position of the focusing lens.

13. The image capturing apparatus according to claim 1, wherein the object image information obtained by the object information obtaining unit includes information regarding an electronic blurring correction.

14. The image capturing apparatus according to claim 2, wherein the object image information obtained by the object information obtaining unit includes information regarding an electronic blurring correction.

15. The image capturing apparatus according to claim 3, wherein the object image information obtained by the object information obtaining unit includes information regarding an electronic blurring correction.

16. An image capturing method comprising:
obtaining image data by capturing an object image formed by a lens;
controlling an acquisition range of the obtained image data to crop a portion of the object image in response to a change of object image information regarding a change of a position of the captured object image;
enlarging image data in the acquisition range; and
displaying the enlarged image data.

17. An image capturing apparatus comprising:
a) an imaging device adapted to (1) receive and capture an image formed on it by a lens system which is coupled with, or included in, the image capturing apparatus, and (2) output image data corresponding to read-out pixels of the imaging device;
b) a display unit adapted to display information based on the image data output from the imaging device;
c) an operation unit adapted to receive manual user command input; and
d) a controller adapted to
(1) receive data indicative of manual user command input received via the operation unit, the data indicative of manual user command input selecting one of (A) a normal live-view mode, and (B) an enlarged-live view mode including a user positioned enlarging frame,
(2) control the imaging device to read out one of (A) pixels of the imaging device corresponding to a normal live-view mode responsive to receipt of data indicative of a selection of a normal live-view mode, and (B) pixels of the imaging device corresponding to the user positioned enlarging frame, adjusted for any change in an angle of view provided by the lens system, responsive to receipt of data indicative of a selection of an enlarged live view mode.

18. The image capturing apparatus of claim 17, wherein the controller is adapted to control the imaging device to read out pixels of the imaging device corresponding to the user positioned enlarging frame, adjusted for a change in an angle of view provided by the lens system such that an object within a user positioned enlarging frame before the change in the angle of view remains within the user positioned enlarging frame after the change in the angle of view, responsive to receipt of data indicative of a selection of an enlarged live view mode.
